(19) United States
(12) Patent Application Publication
(10) Pub. No.: US 2014/0183073 A1
(43) Pub. Date: Jul. 3, 2014

(54) COVER AND CASING FOR AN ELECTRONIC DEVICE AND A METHOD FOR LABELING DEVICES BELONGING TO A FAMILY OF DEVICES

(71) Applicant: SUUNTO OY, Vantaa (FI)

(72) Inventors: Kimmo Pernu, Vantaa (FI); Tapio Selby, Vantaa (FI)

(73) Assignee: SUUNTO OY, Vantaa (FI)

(21) Appl. No.: 13/832,049

(22) Filed: Mar. 15, 2013

Related U.S. Application Data
(60) Provisional application No. 61/747,394, filed on Dec. 31, 2012.

(30) Foreign Application Priority Data
Dec. 31, 2012 (FI) 20126399
Jan. 28, 2013 (GB) 1301467.5

(51) Int. Cl. B65D 85/38; B65C 1/02

(52) U.S. Cl. CPC B65D 85/38; B65C 1/02
USPC 206/305; 156/60

(57) ABSTRACT

The invention relates to a casing for electronic and similar devices. Such casing has a body part and a cover part for covering and to seal the content in the body part. The cover part is a flexible and impermeable foil that extends over an aperture in said body part and onto an essentially even surface surrounding said aperture. The cover part is attached to said surrounding surface by an adhesive.

### FIELD OF THE INVENTION

This invention relates to electronic devices for personal use. More specifically, the invention relates to having a service or battery aperture in a housing for an electronic device covered and sealed in a new way. The invention also relates to a method of using covers for identification of devices. Personal devices are e.g. electronic equipment like wrist computers, heart rate monitors, various sensors like air pressure, magnetic and acceleration sensors, speed and distance measuring units, navigation instruments, medical equipment like pulse oximeters, calorimeters, etc. Exemplary types of devices where the invention may be applied are shown in U.S. Pat. Nos. 4,044,242, 5,778,880, 7,484,320, and 6,779,401.

### BACKGROUND OF THE INVENTION

Covers are needed to seal off battery compartments, various connector and memory/SIM card openings, in order to make the device resistant to moisture and dirt. Usually, if the equipment is provided with several components requiring access from the outside, like a mobile phone, each component has its own opening. These are usually small rubber or plastic pieces, or in the case of battery departments, a threaded plastic disc that can be screwed or snapped into the casing, and/ or a hinged lid of any kind. Such efforts are described e.g. in U.S. Patent applications 2007/0118189 and 2004/0089977, where also the use of a sealing element of rubber, e.g. an O-ring, is shown to ensure that the battery compartment is sealed in a waterproof manner.

In many instances, the cover is thus a rather thick piece of plastic or rubber, and/or there is a need for several of them on the same device. This, in combination with a rather common requirement of the cover to be waterproof, makes the devices unnecessary heavy and large. However, not all devices actually need as such a thick and mechanically almost unbreakable cover. Furthermore, there is usually no frequent need for the user to access the battery compartment or any memory compartment once the memory has been fitted, even less so any other internal parts of the device. A battery must of course be replaced sometimes, but this happens annually, biannually or even more seldom.

Another need stems from the fact that modern outdoor and sporting activities the user may carry several devices. Many such devices are sensors that need a host device, like a wrist computer, for receiving and displaying data. Such devices are heart rate monitors and speed and movement sensors that are integrated in or fitted to clothing or sporting shoes. Such devices communicate with other devices carried by the user, and are therefore usually members of the same family or brand of devices, in order to be interoperable with each other. Each device need their own batteries and typically the sensors and other auxiliary devices are made as small, lightweight and unobtrusive as possible. Therefore, there is a need for having a common “user interface” in terms of battery replacement and other servicing for all devices, and for providing a means to identify each device to the user.

Consequently, there exists a need for a cover of reasonable strength and moisture resistance, that could be used on equipment where miniaturization and lightweight is important. Uncomplicated removal and replacement of such covers is a desirable feature. Typically known covers are hidden on backsides and other surfaces not easily accessible for the user, as they due to their appearance with cuts, notches, hinges and tabs for their opening and closing operations, can be no part of the visual appearance of the device.

### SUMMARY OF THE INVENTION

The present invention is aimed to solve these problems, by offering an entirely new type of device covers. The inventive covers, or lids, are intended to be on top over an aperture in a device casing, to protect and seal off the device from the outside. The cover is a foil that extends and is attached by an adhesive to an area surrounding said aperture.

The invention has numerous advantages. A cover according to the invention is extremely lightweight both in terms of the weight of the cover itself, and the support structures it requires, which is virtually nothing. A flat and even surface is basically enough. One cover in the form of a foil forming a disposable and replaceable sticker can seal off all needed apertures of the device, essentially closing the device hermetically. In this way, the battery opening is hidden by the design.

Such a cover or sticker can carry the brand or logotype of the manufacturer. It can be of different colors, themes and patterns to fit different clothing or moods of the user. Multiple covers can be delivered upon purchase of the device, offered as spare parts, or being part of a battery replacement kit for the product in question.

The sticker may be provided with tags, e.g. visual tags like a barcode, or RFID tags, for providing technical information about the device. An identified tag may activate a smartphone or PDA (Personal Digital Assistant) to connect to a website of the manufacturer or reseller for battery ordering, making a service request, etc.

Stickers with RFID tags may provide necessary communication from an added new device with other devices, e.g. for re-configuration of the user's network of devices. Device cover stickers may also provide authenticity information, as the sticker can be embossed and carry e.g. a hologram.

The adhesive that keeps the cover in place is preferably ready on the cover or sticker itself, but can also be a glue that is separately applied between the cover and the device casing, which are then pressed together. Especially as a backup measure to keep the cover in place in harsh conditions, this is a feasible solution.

### BRIEF DESCRIPTION OF THE DRAWINGS

The invention is in the following described in detail with reference to the drawings, where

FIG. 1 shows a perspective view of an electronic device being provided with a cover according to the present invention;

FIG. 2 shows a cross-sectional view of an electronic device with a cover according to the present invention;

FIG. 3 shows a selection of different covers according to the present invention.

### DETAILED DESCRIPTION OF EXEMPLARY EMBODIMENTS

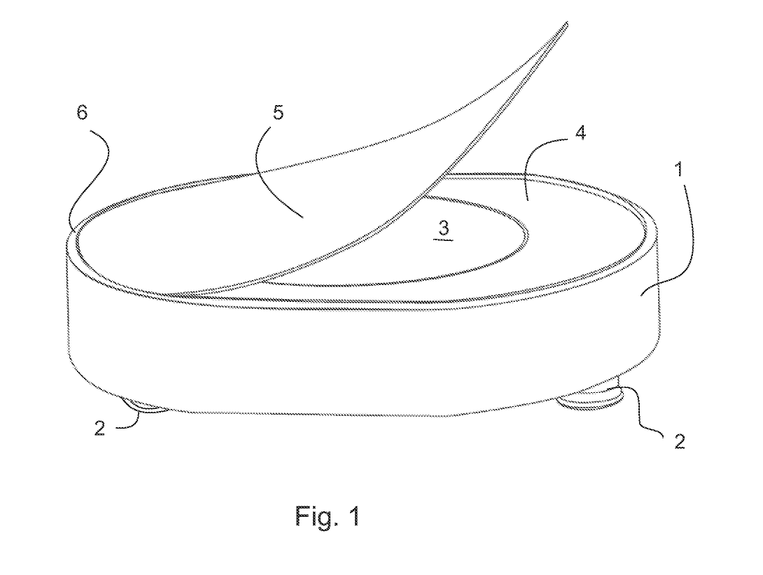

In FIG. 1, a transmitter unit for a telemetric heartbeat rate or pulse monitor device is shown as an example. The unit has a body part 1 and snap fasteners 2 (only one shown) to connect it mechanically and electrically to a belt worn by the user. Such belts are well known in the art, but fastening of a transmitter can also me made directly to clothing having integrated snap fasteners or the like for the purpose. The body part has an opening 3 through which the battery can be removed and replaced, and other possible service steps can be taken, i.e. by accessing an interconnector for software updates etc. The body part also has an even surface 4 for receiving the inventive lid or cover 5. The cover 5 can be a foil or laminate of any size and shape, of a material that is sturdy and waterproof and lends itself to being used as a sticker or glued by an adhesive to an even surface. Such materials include but are in no way limited to laminates or monolayer foils of aluminum or polyester sheets having a thickness of 0.2-1 mm. Further layers for surface finishing may include polyolefin layers or varnish. Alternatively, the outer layer may consist of a polymer like polycarbonate, to provide a hard and stiff surface, but still being transparent for color and textual information printed on a substrate layer underneath. A suitable structure and composition of the cover can be devised by one skilled in the art of producing tags, labels, stickers etc.

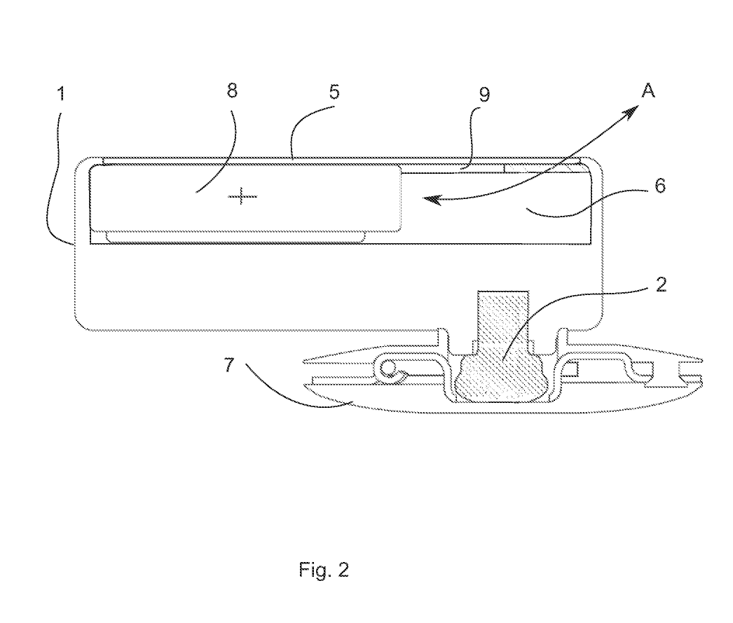

Referring now to FIG. 2, the device body 1 and the snap fastener 2 with its counterpart 7 is shown. The snap fastener “receiver” 7 is part of a transmitter belt (not shown) carried by the user. Inside the device is a battery compartment 6 and a battery 8. The battery can in this embodiment be slided and locked in position and removed as shown by arrow A, once the cover 5 is removed. The surface to which the cover 5 is fastened is here the upper area of element 9, shown partly in cross-section. Element 9 is here an integral part of the body part 1 and runs in an annular fashion around the opening to the battery compartment 6.

As can be seen, the cover 5 can form a lid or cover for essentially the whole device casing, offering an entirely new way of accessing the interior of the device on one hand and having information, colors or brand information showed on top on the other hand.

By using the inventive concept, a method for labeling electronic devices belonging to a family of devices can be envisaged. Such devices are able to communicate, signal, display and/or share data between other devices of the family. According to the method, using a label as a cover, the label is attached to the casing of the device. The label has means for identification of the device, its function or purpose in said family of devices. A typical family of devices would consist of a wrist computer having functionalities including heart rate monitoring, performance measuring, calories consumption calculation and possibly more. Several of these functions require sensors, not all of which can reside in the wrist computer itself. Typical sensors are heart rate transmitters carried on the chest, performance sensors carried on or integrated in sporting shoes, movement sensors to produce a reliable calculation on calories burnt, etc. Such devices using telemetric or low power radio transmission to send measurement or result data to each other are well known in the art.

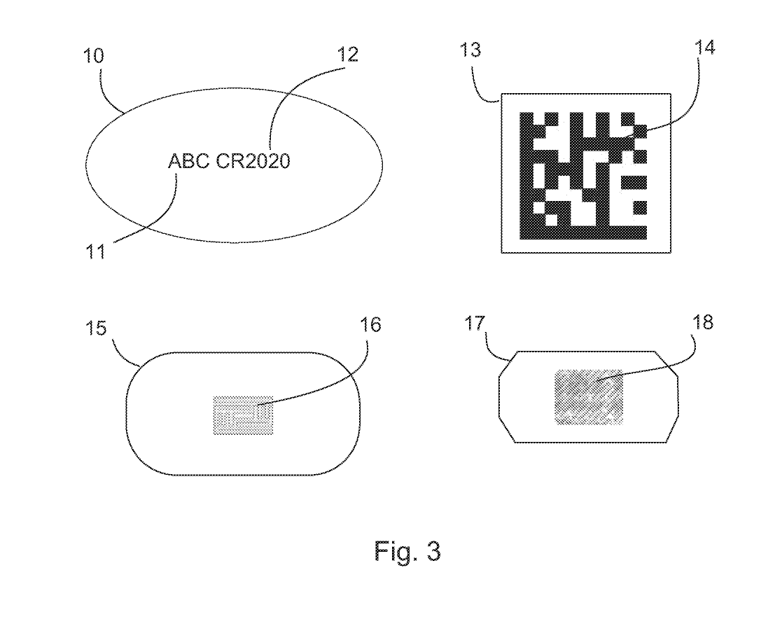

FIG. 3 shows a selection of labels or covers as discussed under reference number 5 above. Label 10 carried textual information, e.g. the name of a manufacturer or the device type 11 “ABC”, and an indication 12 of the type of the battery CR2020, which is a typical 3-volt lithium coin cell battery. Label 13 carries a computer-readable bar-code type tag 14. Label 15 carries an embedded RFID tag 16 and label 17 has a hologram 18, for visual and/or authentication purposes. In addition, the various shapes and colors of the labels can further add to the information to be conveyed to the user of the devices. Clearly, different kinds of information carriers may co-exist on the same label.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A casing for electronic and similar devices, said casing having a body part and a cover part for covering and to seal the content in said body part, wherein the cover part is a flexible and impermeable foil that extends over an aperture said body part and onto an essentially even surface surrounding said aperture, said cover part being attached to said surrounding surface by an adhesive.

2. A casing according to claim 1, wherein said aperture to be covered by said cover part is an opening to the battery compartment of said device.

3. A casing according to claim 1, wherein the cover part is a sticker with a pre-fabricated adhesive.

4. A casing according to claim 3, wherein the cover part is a disposable sticker to be replaced once opened.

5. A casing according to claim 1, wherein the cover includes means for identifying the device.

6. A casing according to claim 1, wherein the cover includes service information for the device.

7. A casing according to claim 5, wherein the means for identifying the device and/or the service information is printed on the cover.

8. A casing according to claim 5, wherein the means for identifying the device is the shape of the cover.

9. A casing according to claim 5, wherein the means for identifying the device and/or providing the service information is a computer-readable symbol.

10. A casing according to claim 5, wherein the means for identifying the device and/or providing service information is an RFID tag embedded in the cover.

11. A casing according to claim 1, wherein the device contained in said casing is a transmitter for a heart rate or pulse monitor.

12. A method for labeling electronic devices belonging to a family of devices by attaching a label to a body part of a casing of a device, said device being able to communicate, signal, display and/or share data between other devices of said family, wherein the label is an impermeable foil having means for identification of said device or its function in said family of devices, and wherein said label is formed as a cover that extends over and overlaps an aperture in said body part of said casing, provided for accessing the device or parts of it, and said cover is arranged to be fastened by an adhesive on a receiving surface surrounding said aperture in said casing.
